(19) United States
(12) Patent Application Publication
(10) Pub. No.: US 2026/0085536 A1
(43) Pub. Date: Mar. 26, 2026

(54) SKIMMER FLOW REGULATOR VALVE

(71) Applicant: Kenneth M. Howard, Solana Beach, CA (US)

(72) Inventor: Kenneth M. Howard, Solana Beach, CA (US)

(21) Appl. No.: 19/335,934

(22) Filed: Sep. 22, 2025

Related U.S. Application Data
(60) Provisional application No. 63/697,229, filed on Sep. 20, 2024.

(51) Int. Cl. E04H 4/12; F16K 5/10; F16K 27/06; F16K 31/50

(52) U.S. Cl. CPC E04H 4/1209; F16K 5/10; F16K 27/06; F16K 31/502

(57) ABSTRACT

A skimmer flow regulator valve for pool systems includes a top rotatably connected to a bottom. At least one top flow passage is defined by the top. At least one bottom flow passage is defined by the bottom. A compressible bolt assembly secures the top to the bottom and includes a bolt, a pair of washers, a spring positioned between the washers, and a nut. A spring force from the spring biases the top towards the bottom, and the spring force prevents rotation between the top and the bottom. The top may be drawn away from the bottom to compress the spring to enable rotation of the top relative to the bottom. The at least one top flow passage and at least one bottom flow passage are operable to be partially or fully aligned to regulate a water flow through the skimmer flow regulator valve.

### I. CROSS-REFERENCE TO RELATED APPLICATIONS

This application claims priority to U.S. Provisional Patent Application Ser. No. 63/679,229, filed Sep. 20, 2024, the entirety of which is incorporated by reference as if fully disclosed herein.

### BACKGROUND OF THE INVENTION

### II. FIELD OF THE INVENTION

The present invention relates generally to a flow control valve for use with pool skimmers.

### III. GENERAL BACKGROUND

In pool systems with multiple skimmers, the suction through each skimmer can often become imbalanced due to the placement of the skimmers or the construction of pool piping system in relation to the pool pump. What is needed is a device that enables a pool operator to adjust the flow of the water through each skimmer to balance to flow across multiple skimmers.

### SUMMARY OF THE INVENTION

In accordance with one embodiment, a skimmer flow regulator valve for pool systems is provided. The skimmer flow regulator valve includes a top rotatably connected to a bottom. At least one top flow passage is defined by the top. At least one bottom flow passage is defined by the bottom. A compressible bolt assembly secures the top to the bottom. The compressible bolt assembly includes a bolt, a pair of washers, a spring positioned between the washers, and a nut. The compressible bolt assembly is operable to secure the top to the bottom. A spring force from the spring biases the top towards the bottom, and the spring force prevents rotation between the top and the bottom. The top may be drawn away from the bottom to compress the spring to enable rotation of the top relative to the bottom. The at least one top flow passage and at least one bottom flow passage are operable to be partially or fully aligned to regulate a water flow through the skimmer flow regulator valve.

In accordance with another embodiment, a skimmer flow regulator valve for pool systems is provided. A top is rotatably connected to a bottom. At least one top flow passage is defined by the top. At least one bottom flow passage is defined by the bottom. A top bolt passage is defined by the top. A bottom bolt passage defined by the bottom. A compressible bolt assembly secures said top to the bottom, and includes a bolt, a pair of washers, a spring positioned between the washers, and a nut. The bolt is inserted through the top bolt passage and through the bottom bolt passage. A spring force from the spring biases the top towards the bottom. The spring force prevents rotation between the top and the bottom. The top may be drawn away from the bottom to compress the spring to enable rotation of the top relative to the bottom. The at least one top flow passage and at least one bottom flow passage are operable to be partially or fully aligned to regulate a water flow through the skimmer flow regulator valve.

In accordance with yet another embodiment, a skimmer flow regulator valve for pool systems is provided. A top is rotatably connected to a bottom. At least one top flow passage is defined by the top. At least one bottom flow passage is defined by the bottom. A top bolt passage is defined by the top. A bottom bolt passage is defined by the bottom. A nut rotation limiter is defined by the bottom. A compressible bolt assembly secures the top to the bottom, and includes a bolt, a pair of washers, a spring positioned between said washers, and a nut. The bolt is inserted through the top bolt passage, through the bottom bolt passage, and into the nut, wherein the nut is contained within the rotation limiter. A spring force from the spring biases the top towards the bottom, and the spring force prevents rotation between the top and the bottom. The top may be drawn away from the bottom to compress the spring to enable rotation of the top relative to the bottom. The at least one top flow passage and at least one bottom flow passage are operable to be partially or fully aligned to regulate a water flow through the skimmer flow regulator valve.

### BRIEF DESCRIPTION OF THE DRAWINGS

The foregoing and other objects, features, and advantages of the invention are apparent from the following detailed description taken in conjunction with the accompanying drawings in which like parts are given like reference numerals and, wherein:

FIG. 1 depicts a bottom view of a bottom of a skimmer flow regulator valve in accordance with embodiments of the invention.

FIG. 2 depicts a side view of a bottom of a skimmer flow regulator valve in accordance with embodiments of the invention.

FIG. 3 depicts a top perspective view of a bottom of a skimmer flow regulator valve in accordance with embodiments of the invention.

FIG. 4 depicts a top view of a top of a skimmer flow regulator valve in accordance with embodiments of the invention.

FIG. 5 depicts a side view of a top of a skimmer flow regulator valve in accordance with embodiments of the invention.

FIG. 6 depicts a top perspective view of a top of a skimmer flow regulator valve in accordance with embodiments of the invention.

FIG. 7 depicts an exploded perspective view of a top of a skimmer flow regulator valve with a bolt assembly in accordance with embodiments of the invention.

FIG. 8 depicts a top perspective view of a skimmer flow regulator valve in a closed position in accordance with embodiments of the invention.

FIG. 9 depicts a top perspective view of a skimmer flow regulator valve in an open position in accordance with embodiments of the invention.

FIG. 10 depicts a bottom perspective view of a skimmer flow regulator valve in closed position in accordance with embodiments of the invention.

FIG. 11 depicts a side view of a skimmer flow regulator valve in accordance with embodiments of the invention.

FIG. 12 depicts a bottom perspective view of a skimmer flow regulator valve in closed position in accordance with embodiments of the invention.

FIG. 13 depicts a schematic view of a pool skimmer illustrating the placement of a skimmer flow regulator valve in accordance with embodiments of the invention.

FIG. 14 depicts a top perspective view of a skimmer flow regulator valve being twisted by a user in accordance with embodiments of the invention.

FIG. 15 depicts a close top perspective view of a skimmer flow regulator valve being twisted by a user in accordance with embodiments of the invention.

FIG. 16 depicts a perspective view of a skimmer flow regulator valve being twisted by a user in accordance with embodiments of the invention.

FIG. 17 depicts a side view of a top of a skimmer flow regulator valve being drawn away from a bottom of a skimmer flow regulator valve by a user in accordance with embodiments of the invention.

The images in the drawings are simplified for illustrative purposes and are not depicted to scale. Within the descriptions of the figures, similar elements are provided similar names and reference numerals as those of the previous figure(s). The specific numerals assigned to the elements are provided solely to aid in the description and are not meant to imply any limitations (structural or functional) on the invention.

The appended drawings illustrate exemplary configurations of the invention and, as such, should not be considered as limiting the scope of the invention that may admit to other equally effective configurations. It is contemplated that features of one configuration may be beneficially incorporated in other configurations without further recitation.

### DETAILED DESCRIPTION

The embodiments of the disclosure will be best understood by reference to the drawings, wherein like parts are designated by like numerals throughout. It will be readily understood that the components, as generally described and illustrated in the Figures herein, could be arranged and designed in a wide variety of different configurations or be entirely separate. Thus, the following more detailed description of the embodiments of the system and method of the disclosure, as represented in the Figures is not intended to limit the scope of the disclosure, as claimed, but is merely representative of possible embodiments of the disclosure.

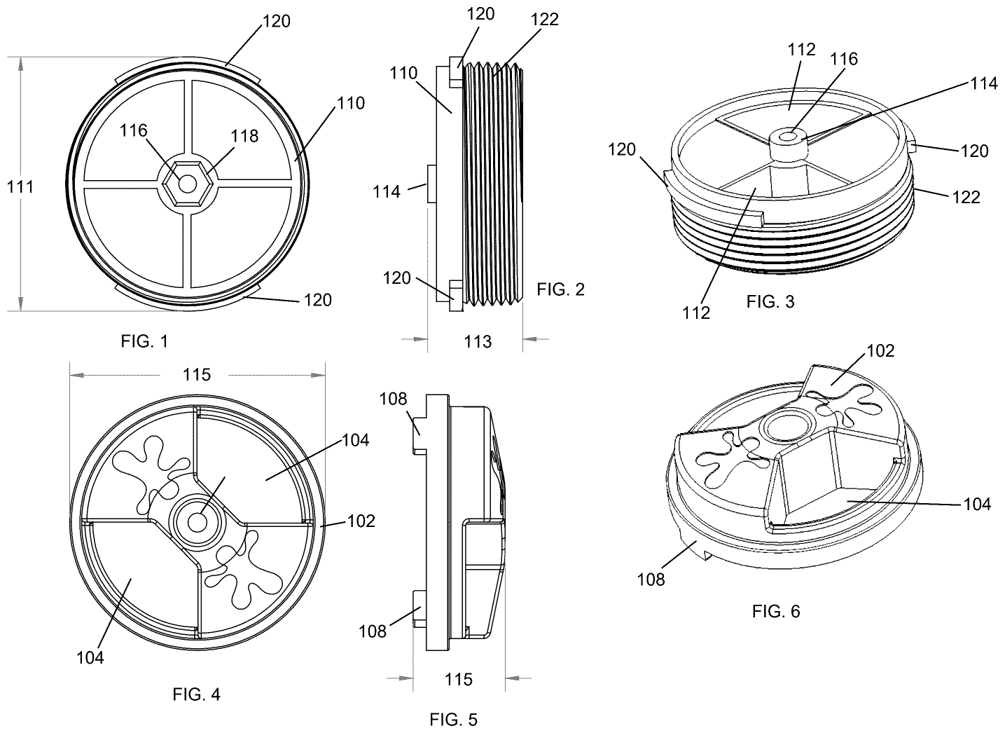

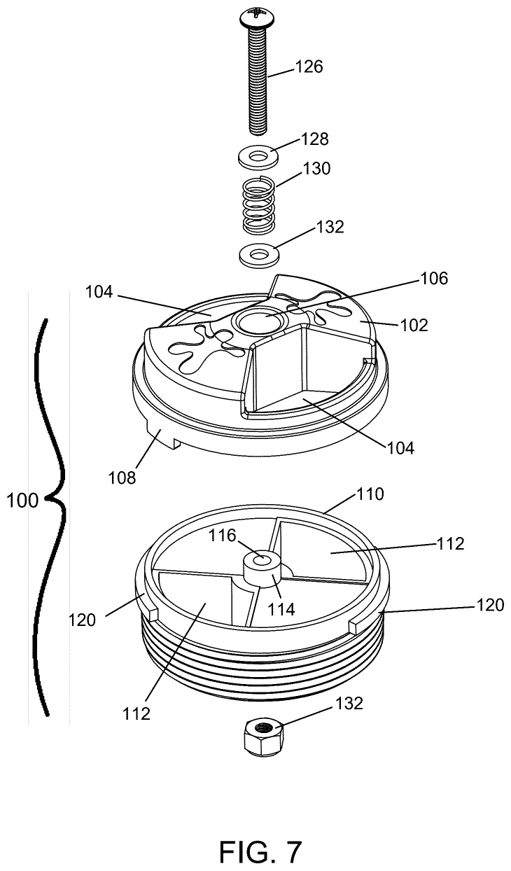

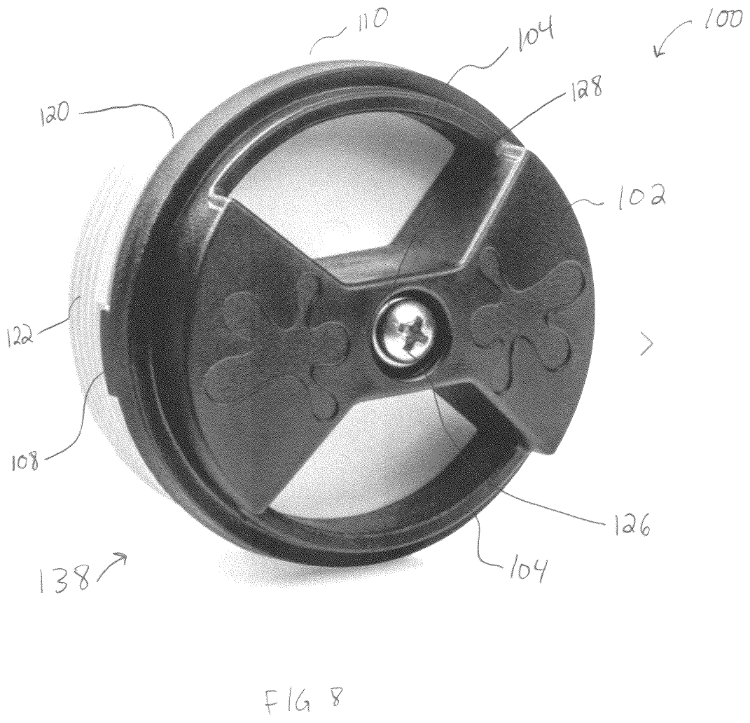

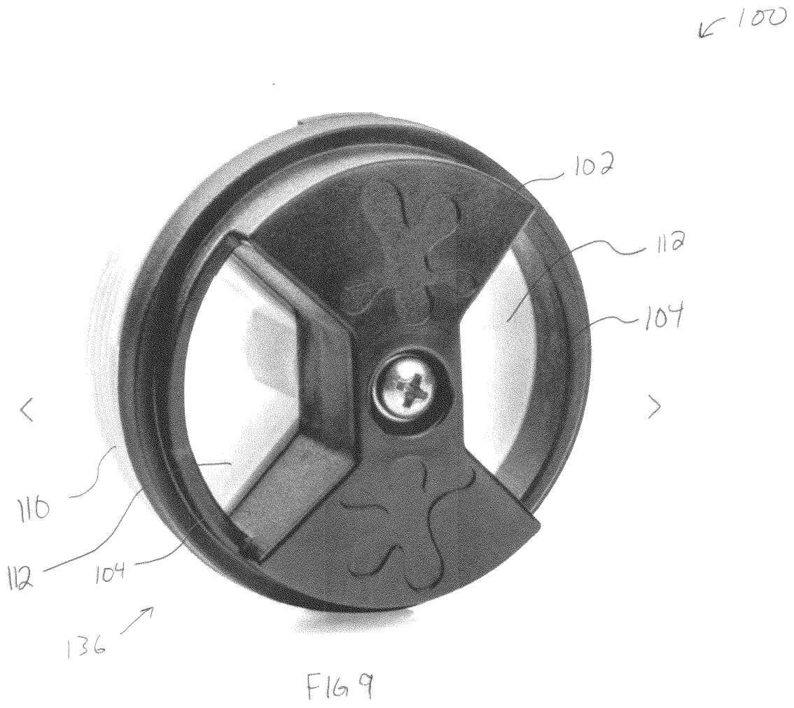

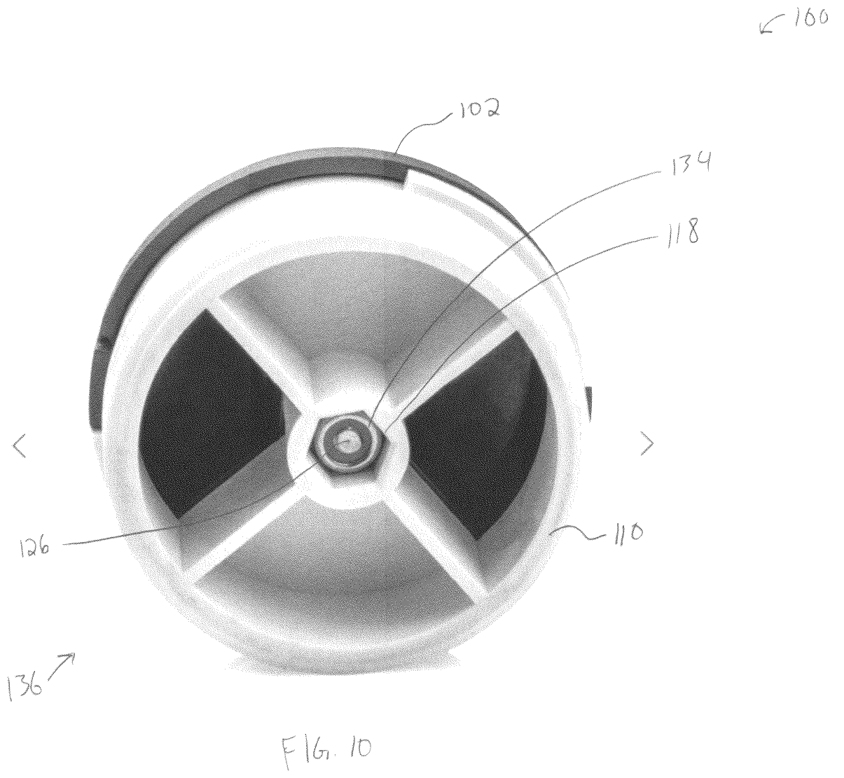

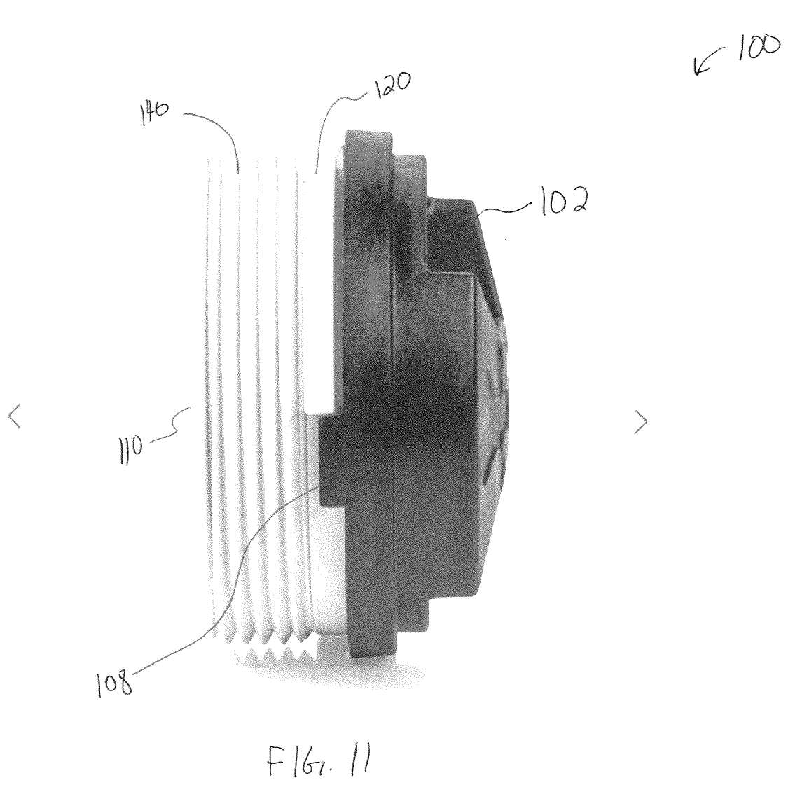

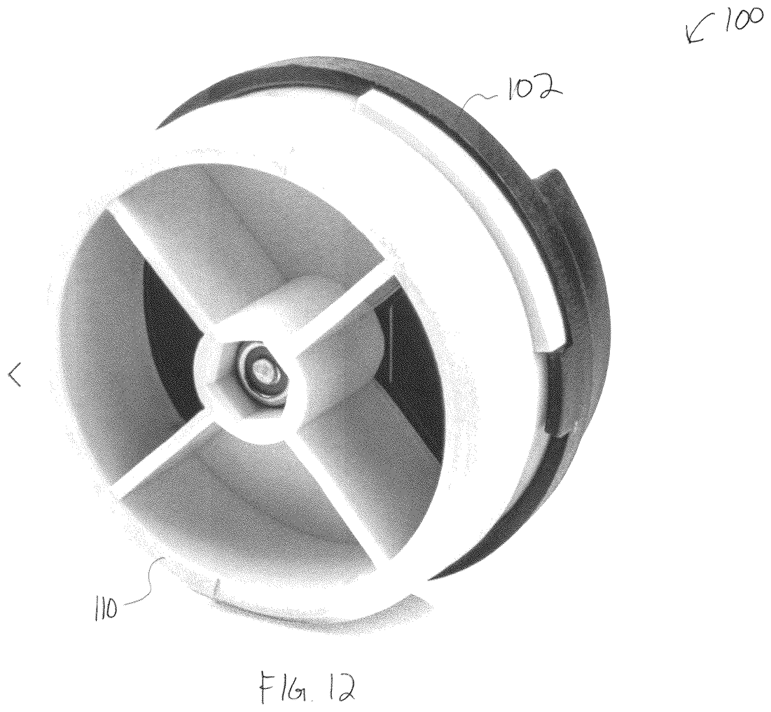

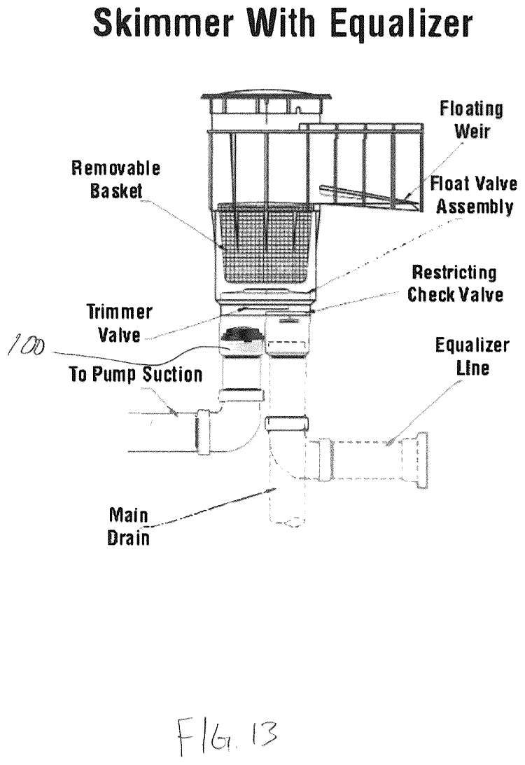

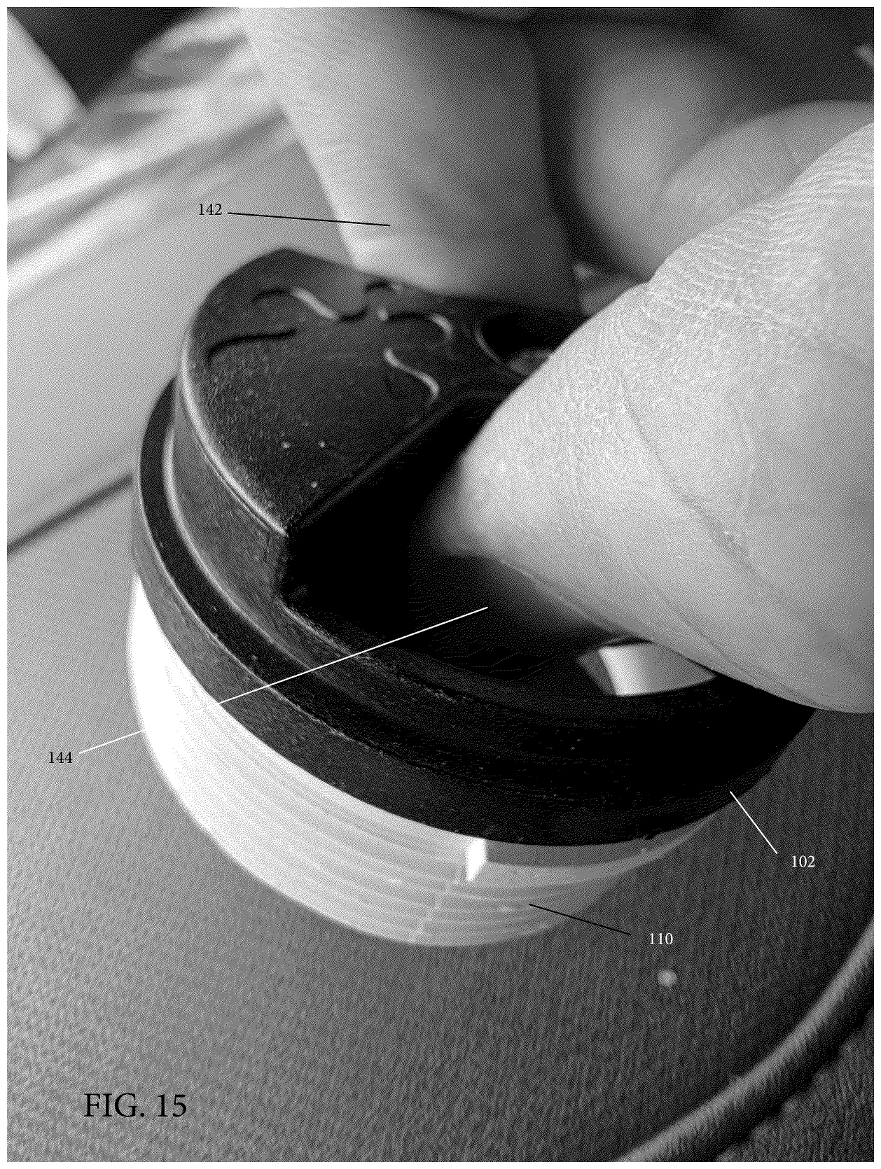

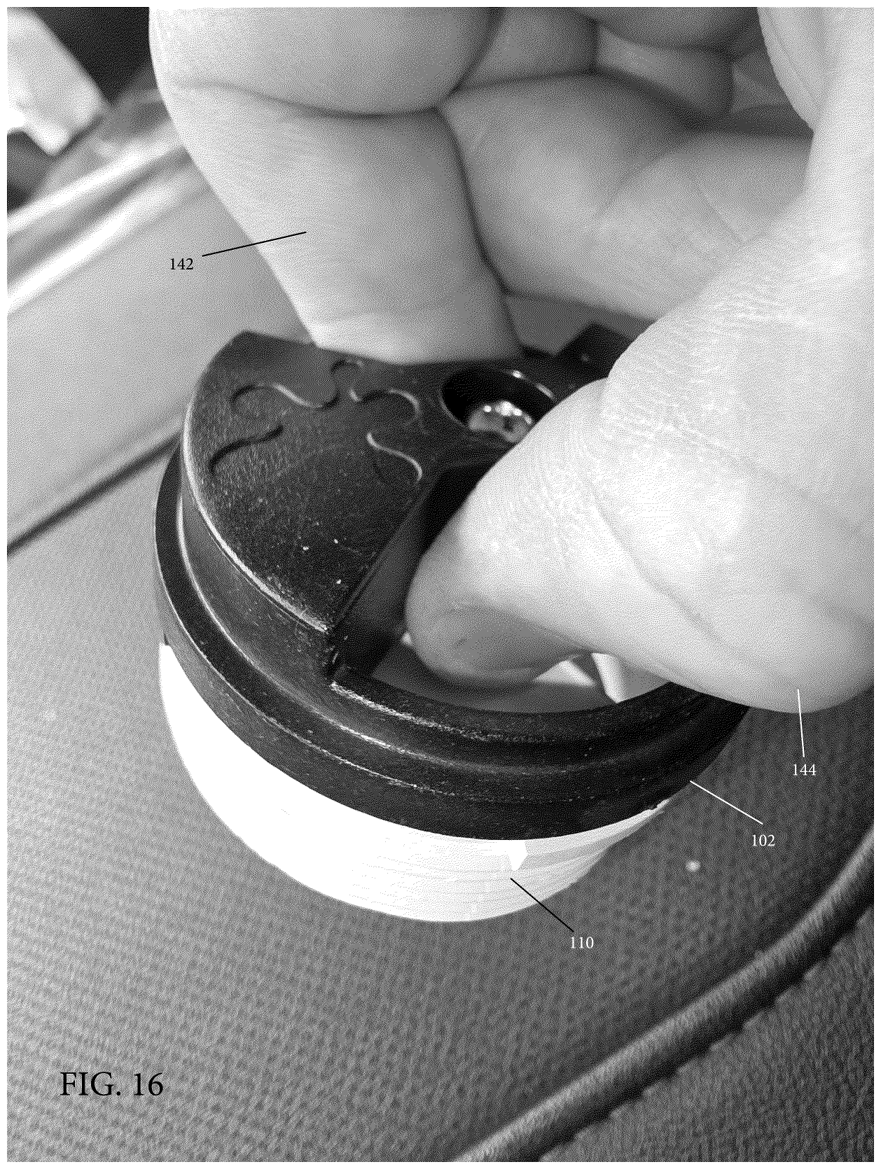

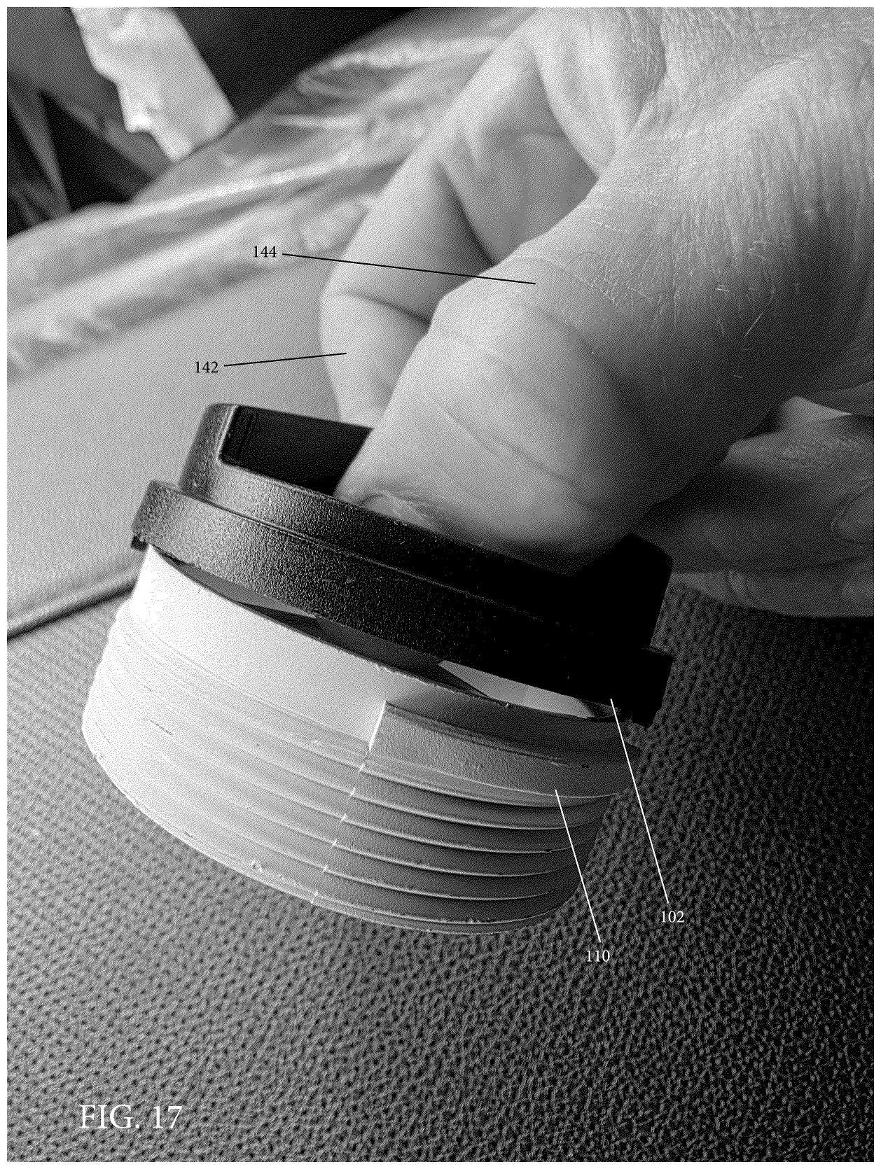

In accordance with embodiments of the invention, a skimmer flow regulator valve 100 for pool systems is provided, as illustrated in FIGS. 1-17. The skimmer flow regulator valve 100 includes a top 102. A pair of top flow passages 104 are defined by the top 102. A top bolt passage 106 is defined by the top 102. A top rotation limiter 108 is attached to the top 102.

The skimmer regulator flow valve 100 includes a bottom 110. A pair of bottom flow passages 112 are defined by the bottom 110. The bottom includes a bolt mount 114. A bottom bolt passage 116 is defined by the bottom 110. A nut recess 118 is defined by the bottom 110. A bottom rotation limiter 120 is attached to the bottom 110. Threads 122 are defined by the bottom 110.

The skimmer regulator flow valve 100 includes a bolt assembly 124. The bolt assembly 124 includes a bolt 126, a first washer 128, a spring 130, a second washer 132, and a nut 134. The top 102 is rotatably secured to the bottom 110 by the bolt assembly 124. The bolt 126 is inserted through the first washer 128, the spring 130, the second washer 132, then inserted through the top bolt passage 106, then seated on the bolt mount 114, the bottom bolt passage 116, and then secured by the nut 134, which is inserted into the nut recess 118, which serves as a nut rotation limiter.

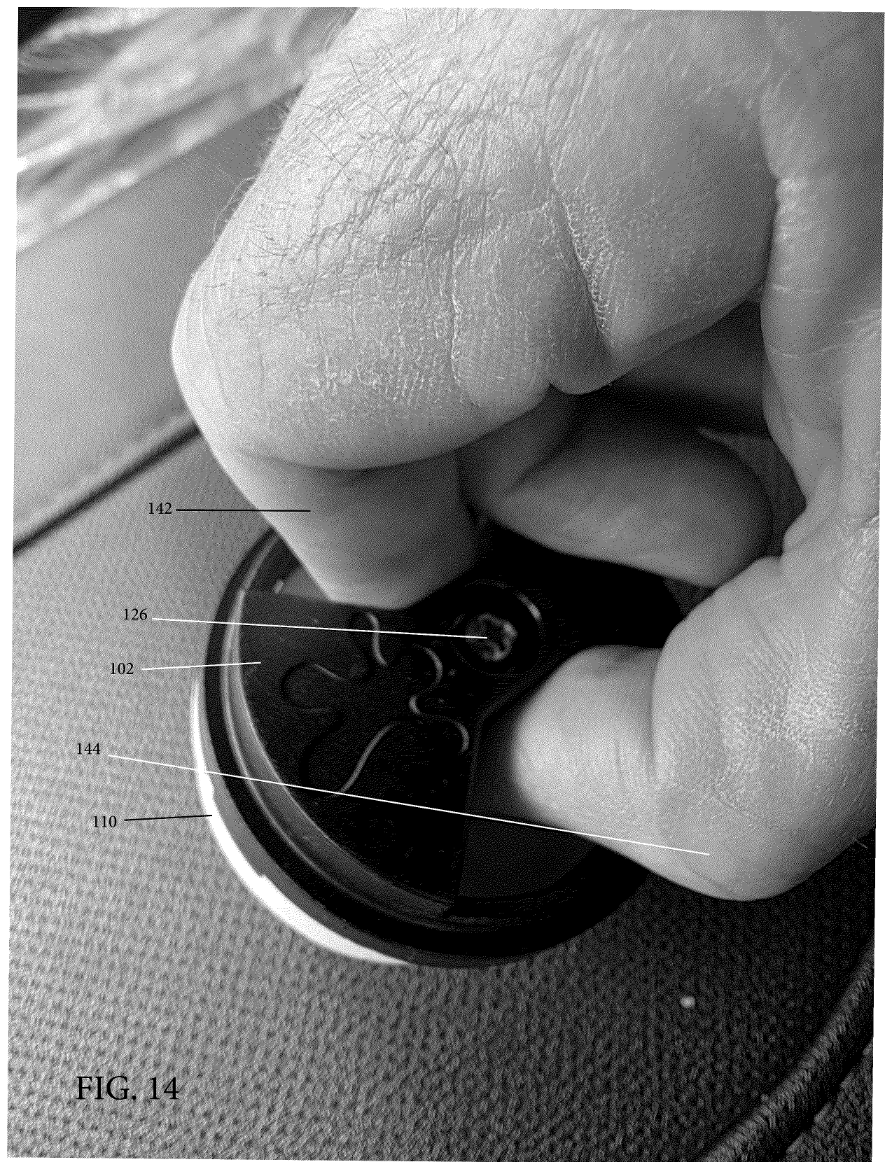

This configuration of bolt assembly 124 in combination with bottom bolt passage 116 provides significant durability and longevity over the prior art methods, which typically involved threading a self-threading screw directly into injected molded material. This prior art configuration of skimmer valves had multiple shortcomings in use. For example, the units tended to unscrew as the tops were rotated relative to the bottom, as the top would twist the screw loose when a user was trying to adjust the flow rate of the valve. The prior art valves used a spring force down onto the top to keep the assembly together. This force would aid in causing the top to unscrew the screw. To correct this issue, the instant invention 100 enables a user to draw the top 102 away from the bottom by compressing the spring 130 towards the head of the bolt 126. Since the screw is secured into the nut 134, which cannot rotate because of the nut recess 118, the top 102 can rotate around the bolt 126 without unscrewing the bolt 126 from the nut 134. Further, with respect to the prior art valves, a downward force by the spring, in conjunction with suction from a pool skimmer, would prevent a user from twisting the valve, as the user could not break the suction from the skimmer. The instant invention 100 enables a user to break the suction by enabling the top 102 to slide up the bolt 126. For example, a user can place one finger 142 and thumb 144 on the top 102 to pull the top 102 away from the bottom 110 and twist the top 102, as illustrated in FIGS. 14-17. This enables the user to break suction from the pool skimmer and rotate the top 102 relative to the bottom 110. This prevents wear and tear under the force of water in the pump suction pipe and from rotation by a user. A longer bolt 126 and spring 130 further enable a user more distance to draw the top 102 away from the bottom 110, as illustrated in FIG. 17.

In one embodiment, bolt 126 is 8-32×1.25 inch. The spring 130 is 0.5 inch in length, 0.3 inch outer diameter, 0.248 inch inner diameter, with a wire diameter of 0.026. Spring 130 has a load max of 1.93 pounds and a spring rate of 9.92 pounds per inch.

In operation, the top rotation limiter 108 and the bottom rotation limiter 120 are operable to limit the rotation of the top 102 relative to the bottom 110. The top 102 is operable to rotate relative to the bottom 110 from an open position 136 to a closed position 138. When in the open position 136, the pair of top flow passages 104 and the pair of bottom flow passages 112 are aligned to enable flow through the skimmer flow regulator valve 100. When in the closed position 138, the top 102 and the bottom 110 are operable to restrict flow through said skimmer flow regulator valve 100 in the closed position 138. The amount of flow through the skimmer flow regulator valve 100 may be varied by rotating the top 102 partially between the open position 136 and the closed position 138 to vary the size of the openings created by the top flow passages 104 and bottom flow passages 116. The threads 140 defined by the bottom 110 are operable to be connected into the suction line of a pool skimmer, as illustrated in FIG. 13. The skimmer flow regulator valve 100 may have 1.5 inch or 2 inch NPT threads, for example.

Referring to FIG. 1, bottom 110 may have an outer diameter 111 of 2.42 inches. Referring to FIG. 2, bottom 110 may have a height 113 of 0.903 inches. Referring to FIG. 4, top 102 may have an outer diameter 115 of 2.432 inches. Referring to FIG. 5, top 102 may have a height 117 of 0.875 inches.

Skimmer flow regulator valve 100 provides multiple benefits over the prior art. Pool systems with multiple skimmers often have imbalanced suction across skimmers. This can be due to placement, distance from the pump, bends in the pipe, etc. When skimmers are imbalanced, water tends to favor some skimmers over others, leading to ineffective skimming. By placing skimmer flow regulator valves 100 in each skimmer, a pool operator can adjust the opening of the skimmer flow regulator valve 100 to allow more or less flow through the suction pipe to of each skimmer to equalize the flow across the multiple skimmers. When the skimmer flow regulator valves 100 are added to a pool system, they instantly cause better skimming by creating more velocity, as less water is required to move through each skimmer, and the same amount of water is moving through each skimmer. The skimmer flow regulator valves 100 maximizes the skimmer flow when you need to vacuum through the skimmer or if you have two skimmers you need to regulate the flow between.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the system (and components of the individual operating components of the system) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A skimmer flow regulator valve for pool systems, comprising:
a top rotatably connected to a bottom;
at least one top flow passage defined by said top;
at least one bottom flow passage defined by said bottom;
a compressible bolt assembly securing said top to said bottom, said compressible bolt assembly comprising a bolt, a pair of washers, a spring positioned between said washers, and a nut;
wherein a spring force from said spring biases said top towards said bottom, and said spring force prevents rotation between said top and said bottom;
wherein said top may be drawn away from said bottom to compress said spring to enable rotation of said top relative to said bottom; and
wherein said at least one top flow passage and at least one bottom flow passage are operable to be partially or fully aligned to regulate a water flow through said skimmer flow regulator valve.

2. The skimmer flow regulator valve for pool systems of claim 1, further comprising a nut recess defined by said bottom, said nut recess operable to prevent rotation of said nut.

3. The skimmer flow regulator valve for pool systems of claim 2, wherein said nut recess is hexagonal.

4. The skimmer flow regulator valve for pool systems of claim 2, wherein said nut recess is operable to fully receive a nut.

5. A skimmer flow regulator valve for pool systems, comprising:
a top rotatably connected to a bottom;
at least one top flow passage defined by said top;
at least one bottom flow passage defined by said bottom;
a top bolt passage defined by said top;
a bottom bolt passage defined by said bottom;
a compressible bolt assembly securing said top to said bottom, said compressible bolt assembly comprising a bolt, a pair of washers, a spring positioned between said washers, and a nut;
wherein said bolt is inserted through said top bolt passage and through said bottom bolt passage;
wherein a spring force from said spring biases said top towards said bottom, and said spring force prevents rotation between said top and said bottom;
wherein said top may be drawn away from said bottom to compress said spring to enable rotation of said top relative to said bottom; and
wherein said at least one top flow passage and at least one bottom flow passage are operable to be partially or fully aligned to regulate a water flow through said skimmer flow regulator valve.

6. The skimmer flow regulator valve for pool systems of claim 5, further comprising a nut recess defined by said bottom, said nut recess operable to prevent rotation of said nut.

7. The skimmer flow regulator valve for pool systems of claim 6, wherein said nut recess is hexagonal.

8. The skimmer flow regulator valve for pool systems of claim 6, wherein said nut recess is operable to fully receive a nut.

9. A skimmer flow regulator valve for pool systems, comprising:
a top rotatably connected to a bottom;
at least one top flow passage defined by said top;
at least one bottom flow passage defined by said bottom;
a top bolt passage defined by said top;
a bottom bolt passage defined by said bottom;
a nut rotation limiter defined by said bottom;
a compressible bolt assembly securing said top to said bottom, said compressible bolt assembly comprising a bolt, a pair of washers, a spring positioned between said washers, and a nut;
wherein said bolt is inserted through said top bolt passage, through said bottom bolt passage, and into said nut, wherein said nut is contained within said rotation limiter;
wherein a spring force from said spring biases said top towards said bottom, and said spring force prevents rotation between said top and said bottom;
wherein said top may be drawn away from said bottom to compress said spring to enable rotation of said top relative to said bottom; and
wherein said at least one top flow passage and at least one bottom flow passage are operable to be partially or fully aligned to regulate a water flow through said skimmer flow regulator valve.

10. The skimmer flow regulator valve for pool systems of claim 9, wherein said nut rotation limiter is a nut recess defined by said bottom, said nut recess operable to prevent rotation of said nut.

11. The skimmer flow regulator valve for pool systems of claim 10, wherein said nut recess is hexagonal.

12. The skimmer flow regulator valve for pool systems of claim 11, wherein said nut recess is operable to fully receive a nut.
